(19) United States
(12) Patent Application Publication
(10) Pub. No.: US 2007/0179935 A1
(43) Pub. Date: Aug. 2, 2007

(54) Apparatus and method for efficient data pre-filtering in a data stream

(76) Inventors: Tsern-Huei Lee, Fremont, CA (US); Jo-Yu Wu, Sunnyvale, CA (US)

Correspondence Address: CARLTON FIELDS, PA, 1201 WEST PEACHTREE STREET, 3000 ONE ATLANTIC CENTER, ATLANTA, GA, 30309, US

(21) Appl. No.: 11/344,302

(22) Filed: Jan. 31, 2006

(51) Int. Cl. G06F 17/30

(52) U.S. Cl. 707/3

(57) ABSTRACT

An apparatus and method for enabling rapid transfer of safe data in a data communication network. The apparatus includes a plurality of query modules, a search window, a shift detector, and a database of unsafe data. A predetermined portion of the unsafe data's signature is populated into the query modules, and the signature of a received data in the search window is compared against a plurality of query modules. The search window is shifted according to the result of comparison with the plurality of query modules detected by the shift detector.

### BACKGROUND OF THE INVENTION

1. Field of the Invention

The present invention generally relates to data communications, and more specifically, relates to a system and method for providing security in during data transfers.

2. Description of the Related Art

Computer viruses and worms have caused millions dollars in computer and network downtimes and they made computer virus detection and elimination a thriving industry. Now, every computer is equipped with computer virus detection and prevention software, and every data network gateway is guarded with equally powerful virus detection and prevention software.

Computer virus, bugs, and worms are undesirable software developed by computer hackers or computer whiz kids, who are either testing their programming skills or having other ulterior motives. Like any software, each of these undesired viruses, bugs and worms have a unique digital signature. Once a virus became known, its digital signature is cataloged and made public. Once a virus's signature is known, computer virus prevention software can test incoming data in a data stream for this particular signature. If an incoming data contains this signature, then it is flagged as unsafe or undesirable data and rejected.

The computer virus prevention software tests an incoming data against signatures of all known viruses, which number is in tens of thousands and still growing. Comparing each incoming data against a growing database of known viruses can be time consuming and slows down data traffic. To ensure a virus free environment, this comparison or screening of data is performed by all network gateways and on every single computer. This “global” comparison slows down substantially the data traffic, even when the majority of the data trafficking in a network at any given time is free of viruses, i.e., they are safe data.

Therefore, it is desirous to have an apparatus and method that enable pre-filtering of incoming data in a data communication system, and it is to such apparatus and method the present invention is primarily directed.

### SUMMARY OF THE INVENTION

Briefly described, an apparatus and method of the invention enables efficient pre-filtering of an incoming data by quickly identifying possible computer viruses and forwarding them for further identification. In one embodiment, there is provided a method for a computing device to identify undesirable data in a data stream, wherein the data stream is received from a network and may contain undesirable data and the computing device has a plurality of undesirable data. The method comprises the steps of creating a database of undesirable data, populating a plurality of query modules with the undesirable data from the database, receiving a data stream, loading a search window with data from the data stream, comparing the search window with the plurality of query modules, and, if a first comparison result indicates no shifting, identifying the data stream as undesirable data.

In another embodiment, there is provided an apparatus for identifying unsafe data in a data stream, wherein the data stream is received from a network and each unsafe datum being identified by a unique data signature. The apparatus comprises a data receiver for receiving a data stream from a data source, a search window for loading data from the data stream, a plurality of query modules, and a shift detector for receiving results from the plurality of query modules. Each query module is populated with unsafe data and capable of comparing the data with the data in the search window, and, if the shift detector indicates no shifting, the data stream is classified as unsafe data.

In yet another embodiment, there is provided a method for a computing device to identify undesirable data in a data stream, wherein the data stream is received from a network and may contain undesirable data, and the computing device has a plurality of undesirable data. The method comprises the steps of creating a database of undesirable data, populating a plurality of query modules with the undesirable data from the database, receiving the data stream, loading a search window with data from the data stream, comparing the search window with the plurality of query modules, ANDing a first comparison result with a master bitmap, and, if an ANDing result indicates no shifting, identifying the data stream as undesirable data.

In yet another embodiment, there is provided a computer-readable medium on which is stored a computer program for a computing device to identify undesirable data in a data stream. The data stream is received from a network and may contain undesirable data, and each undesirable datum being identified by a unique data signature. The computing device has a plurality of undesirable data signatures identifying undesirable data. The computer program comprises computer instructions that when executed by a computing device performs the steps for creating a database of undesirable data, populating a plurality of query modules with the undesirable data from the database, receiving the data stream, loading a search window with data from the data stream, comparing the search window with the plurality of query modules, and, if a first comparison result indicates no shifting, identifying the data stream as undesirable data.

The present system and methods are therefore advantageous as they enable quick identification of possible computer viruses in a data communication system. Other advantages and features of the present invention will become apparent after review of the hereinafter set forth Brief Description of the Drawings, Detailed Description of the Invention, and the Claims.

### BRIEF DESCRIPTION OF THE DRAWINGS

FIG. 1 depicts a data flow for a pre-filtering process.

FIG. 2 illustrates a filter architecture.

FIG. 3 illustrates a filter architecture with a master bitmap.

FIG. 4 illustrates query modules populated with unsafe data.

FIG. 5 illustrates an example of a querying process.

FIG. 6 is a follow up example after the query process of FIG. 5

FIG. 7 illustrates an example of a false positive.

FIGS. 8 and 9 illustrate an example using a master bitmap.

FIG. 10 illustrates memory accesses when a search window shifts.

FIG. 11 illustrates an architecture of a system supporting the pre-filtering process.

FIG. 12 is a flow chart for a pre-filtering process.

### DETAILED DESCRIPTION OF THE INVENTION

In this description, the term “application” as used herein is intended to encompass executable and nonexecutable software files, raw data, aggregated data, patches, and other code segments. The term “exemplary” is meant only as an example, and does not indicate any preference for the embodiment or elements described. Further, like numerals refer to like elements throughout the several views, and the articles “a” and “the” includes plural references, unless otherwise specified in the description.

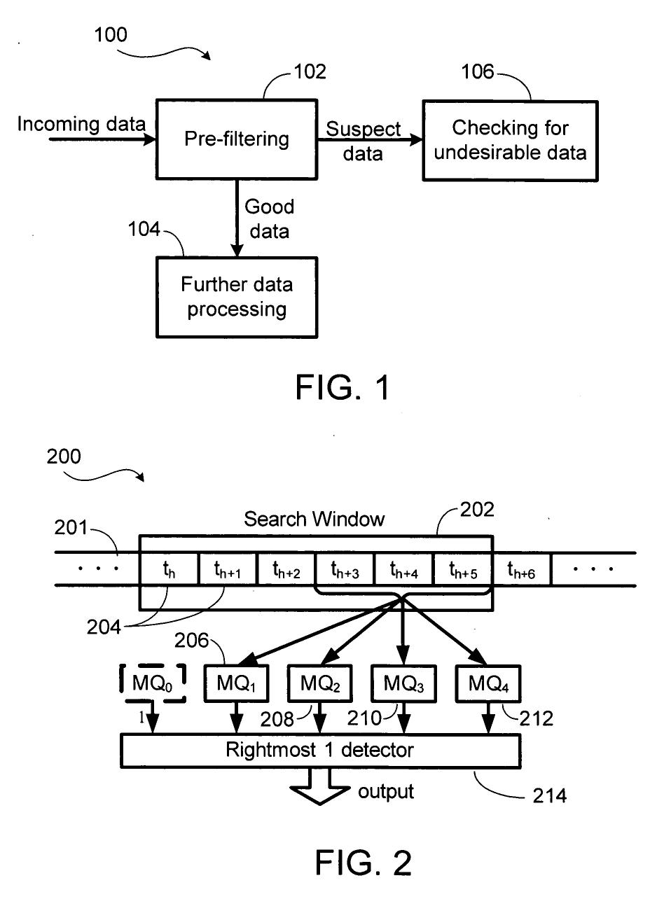

In overview, the present system and method an efficient pre-filtering scheme for string matching which can be used in text editing, searching, and Internet security appliances. FIG. 1 depicts the data flow 100 according to the basic principle of the pre-filtering mechanism of the invention. As stated above, the majority of incoming data is safe data and they should be handled quickly, so as not to hinder the performance of a system. Only the suspect data should be further analyzed. All incoming data pass through pre-filtering 102, where the incoming data are compared with a database of known unsafe data. The good data are identified and sent to their destination for further processing 104; the suspect data, i.e., those data that failed the pre-filtering are sent for further checking 106.

The pre-filtering is done by comparing the signature of an incoming data with signatures of known unsafe data, which includes virus, spyware, attacks, and unauthorized contents. However, instead of comparing the signature of the incoming data with signatures of every known unsafe data, the pre-filtering compares the signature of the incoming data with a select portion of every unsafe data. If there is no match, then the incoming data is classified as safe data. If a portion of the signature of the incoming data matches the select portion of an unsafe data, then the incoming data is a suspect data, i.e., the incoming data may contain unsafe data.

The comparison of signatures involves matching strings and is described as follows. Given a set of patterns P={P₁, P₂, . . . , Pₙ} and a text T, all sequences of symbols over a finite alphabet Σ of size σ, find all pattern occurrences in T. There are some algorithms (such as Aho-Corasick) to solve this problem. However, it is very time consuming in practice. An effective pre-filtering scheme can speed up the matching process by excluding portions of the text without missing any pattern occurrence in T.

It is assumed that all patterns are of the same length m, i.e., |Pᵢ|=m for all i, 1≦i≦n. For patterns of different lengths, one can truncate the patterns so that the truncated ones are of the same length. For ease of description, let Pᵢ=p₁ⁱ p₂ⁱ . . . pₘⁱ and T=t₁t₂ . . . tᵣ. The pre-filter design may be implemented through m−k+1 membership query modules, where k, called block size, is a design parameter. For pattern Pᵢ, the sub-string p₁ⁱ p₂ⁱ . . . pₖⁱ is a member stored in a first membership query module, the sub-string P₂ⁱ p₃ⁱ . . . Pₖ₊₁ⁱ is a member stored in a second membership query module, . . . , and the sub-string Pₘ₋ₖ₊₁ⁱPₘ₋ₖ₊₂ . . . Pₘⁱ is a member stored in a (m−k+1) (or the last) membership query module. For convenience, the membership query modules will be referred to as MQ₁, MQ₂, . . . , and MQₘ₋ₖ₊₁. Moreover, every membership query module reports a 1 if the query result is positive and 0 otherwise. Note that the membership query modules should not result in false negatives; otherwise, some pattern occurrences in T may be missed. However, to be efficient in query speed and storage requirement, one may allow false positives as long as its probability is under a pre-determined threshold. An example of a typical realization of the membership query modules is the Bloom filter that never results in false negatives and whose false positive probability can be well controlled by providing sufficient memory.

A search window W of length m is used in the text searching process. Initially, W is aligned with text T so that the first symbol of T, i.e., t₁, is at the first position of search window W. The last k symbols of T in the search window, i.e., tₘ₋ₖ₊₁tₘ₋ₖ₊₂ . . . tₘ, are used to query MQ₁, MQ₂, . . . , and MQₘ₋ₖ₊₁. If all membership query modules report 0's, i.e., there is no match, then the search widow is advanced by m−k+1 positions. In other words, symbol tₘ₋ₖ₊₂ is at the first position of the search window after advancement. Assume that at least one membership query module reports a 1. Let MQᵢ be the membership query module with the largest index which reports a 1. In this case, the search window is advanced by m−k+1−i positions. Note that if i=m−k+1, then the search window is not advanced and a potential pattern occurrence starting from the symbol at the first position of the search window is found. A verification scheme is required to check whether or not there is indeed a pattern occurrence. The process repeats until the whole text is examined. To combine the above two cases (i.e., all membership query modules report 0's and at least one membership query module reports a 1), it is added a virtual membership query module MQ₀ which always reports a 1.

FIG. 2 shows the architecture 200 of our pre-filter design for m=6 and k=3. An incoming data stream 201 has part of its data examined under a search window 202, texts Tₕ₋Tₕ₊₅ 204 are within the search window 202. Since k=3, texts Tₕ₊₃-Tₕ₊₅ are examined against virus signatures in query modules MQ₁-MQ₄. The results from these query modules are then fed into a shift detector (rightmost 1 detector) 214.

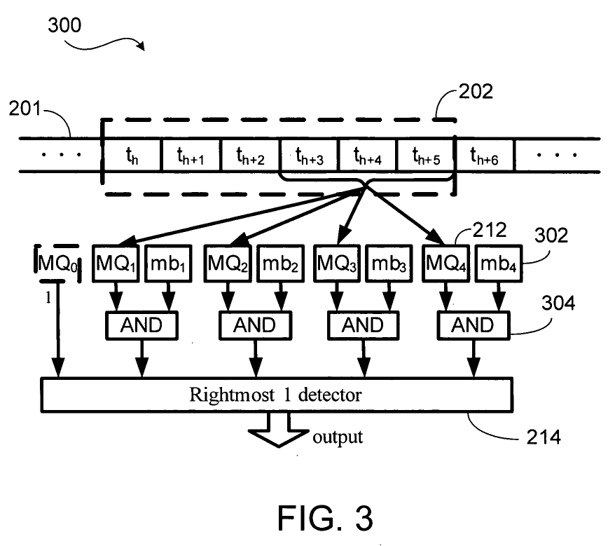

One possible implementation of the above proposed pre-filtering scheme is to store corresponding bits of MQ₁, MQ₂, . . . , and MQₘ₋ₖ₊₁ in contiguous bit locations so that the whole result can be fetched in one memory access operation. It is obvious that such an arrangement can minimize the number of memory access for every query. Moreover, a “master” bitmap of size (m−k+1) bits can be used to accumulate results from different queries. Let MB =mb₁mb₂ . . . mbₘ₋ₖ₊₁ represent the master bitmap and QB=qb₁qb₂ . . . qbₘ₋ₖ₊₁ denote the query bits, where bᵢ is the report of MQᵢ. Initially, the master bitmap contains all 1's, i.e., aᵢ=1 for all i, 1≦i≦m−k+1. After the query result is fetched, we perform MB ⊕ QB, where ⊕ is the bitwise AND operation. Let R=r₁r₂ . . . rₘ₋ₖ₊₁ be the result of the bitwise AND operation. The search window is advanced by m−k+1 positions if rᵢ=0 for all i, 1≦i≦m−k+1 and by m−k+1−i positions if rᵢ=1 and rⱼ=0 for all j, i<j≦m−k+1. If the search window is decided to be advanced by g positions, the master bitmap is right-shifted by g bits and filled with 1's for the holes left by the shift. Note that with the master bitmap, one can often advance the search window more positions compared with a straightforward implementation without using the master bitmap. FIG. 3 shows the pre-filter architecture 300 with master bitmap for m=6 and k=3. An incoming data stream 201 has part of its data examined under a search window 202, texts Tₕ₋Tₕ₊₅ 204 are within the search window 202. Since k=3, texts Tₕ₊₃-Tₕ₊₅ are examined against virus signatures in query modules MQ₁-MQ₄. The results from these query modules are bitwise ANDed with corresponding bits from the master bitmap 302 and then fed into a shift detector (rightmost 1 detector) 214.

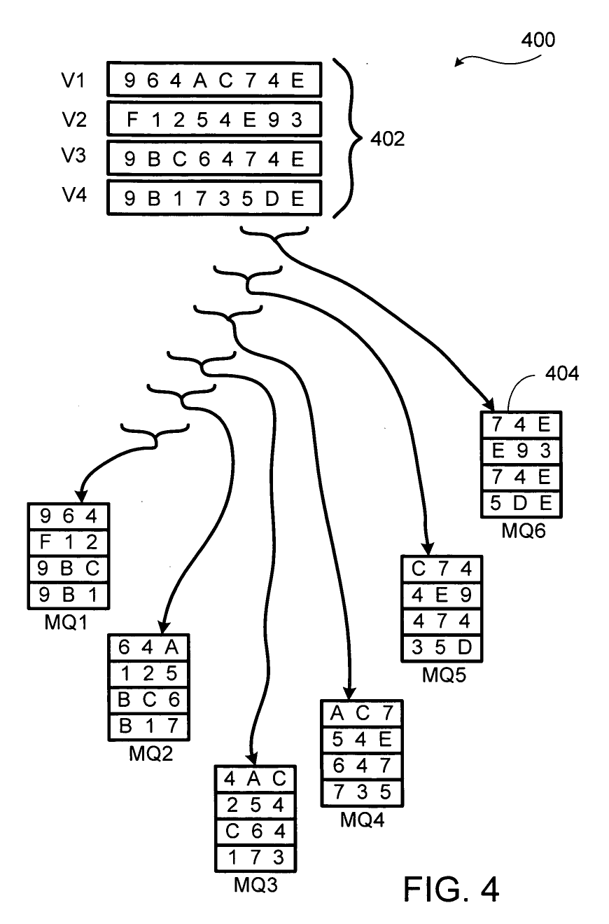

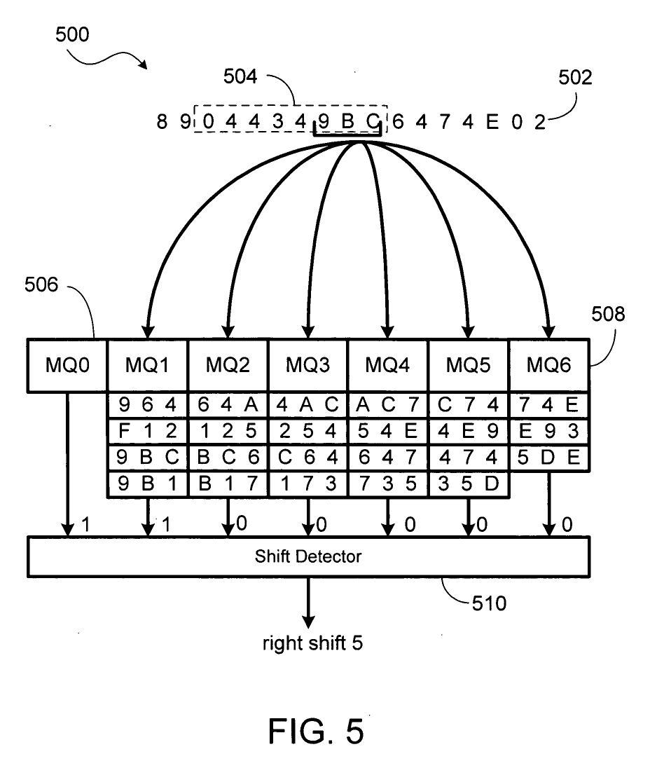

Below is an example of a pre-filtering scheme according to the one embodiment of the invention. FIG. 4 illustrates a table 402 with four viruses. For the example, m is set to 8 and k set to 3. So each three data of every virus are put into a query module 404. For query module MQ6, last three data of each virus are stored here; however, since the last three data of viruses V1 and V3 are identical, these three bytes are stored only once to save memory space. After the query modules are populated with the virus information, they are used to compare with incoming data as shown in FIG. 5. The table 402 is arranged in such a way that when the table 402 is stored in the memory, corresponding bits of MQ1, MQ2, MQ3, MQ4, MQ5, and MQ6 are stored in contiguous bit locations. By storing the table 402 this way, the query modules 404 can be loaded with a minimum number of memory accesses.

FIG. 5 illustrates an incoming data query process 500. The incoming data 502 is scanned and compared with a virus data base with use of query modules 508. A search window 504 covering 8 data is used for query (m=8). It is shown that [0 4 4 3 4 9 B C] in the search window 504 and [9 B C] are used for querying with query modules 508. An optional query module MQ0 is added for reasons stated above and MQ0 always returns 1. In the example of FIG. 5, [9 B C] matches a set stored in MQ1, thus the query module MQ1 returns 1 while other modules return 0. The shift detector 510 receives the results from the query modules 508 and outputs a shift order of 5, since m−k+1−i ->8−3+1−1=5.

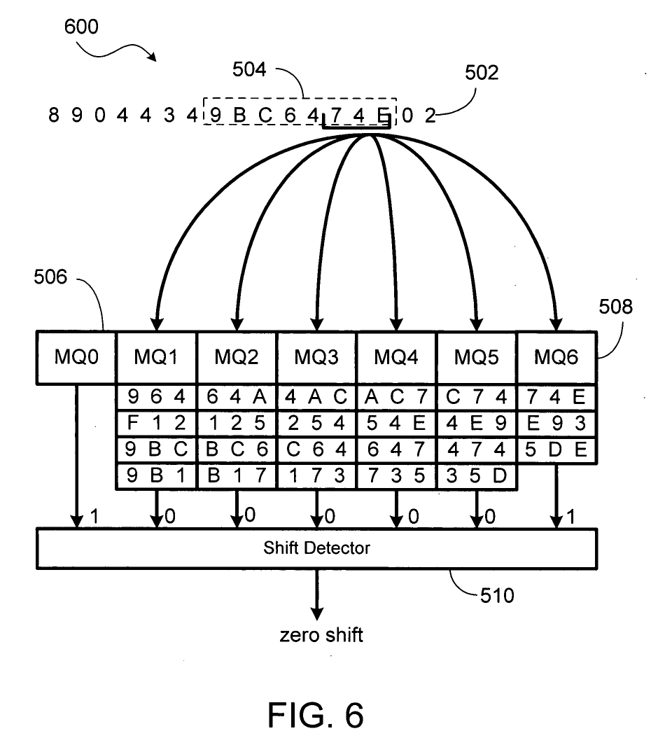

FIG. 6 illustrates the incoming data query process 600 after right shifting the search window by 5. After the shift, the search window 504 covers [9 B C 6 4 7 4 E] and [7 4 E] is used for further comparison. The comparison through the query modules yields the query module MQ6 returning 1. Since MQ6 returns 1, then the shift will be zero (8−3+1−6=0). When the shift is zero, the data in the search window may contain virus and the incoming data should be sent for further virus checking. In the particular example, the data in the search window matches virus V3. It is noted that if after the shift, the data for comparison is not [7 4 E], [E 9 3], or [5 D E], then MQ1-MQ6 will return 0s and the shift number will be 8−3+1−0=6. This illustrates that, though [9 B C] is part of a virus, the process repeats itself if the rest of the virus is not present.

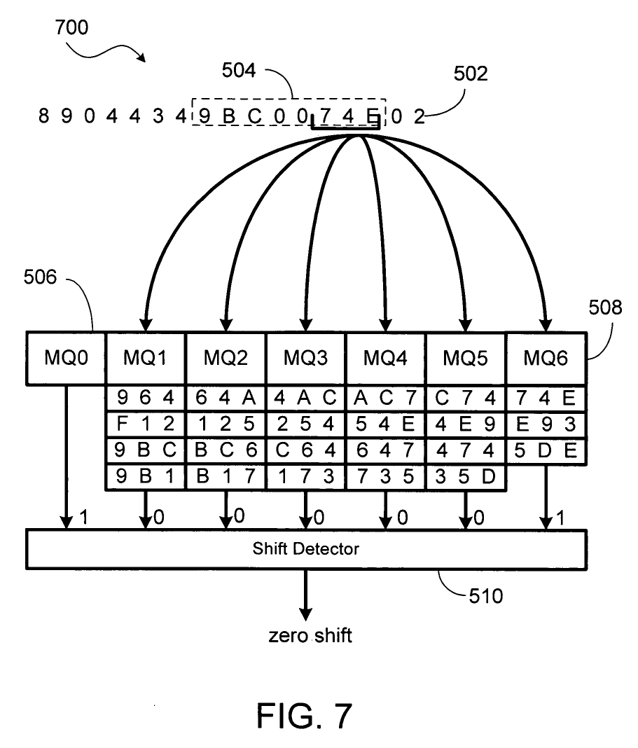

In an alternative embodiment, let's assume that, at some moment, symbol tₕ is at the first position of the search window and substring tₕ₊ₘ₋ₖtₕ₊ₘ₋ₖ₊₁ . . . tₕ₊ₘ₋₁ is used to query MQ₁, MQ₂, . . . , and MQₘ₋ₖ₊₁. Let MQᵢ be the membership query module with the largest index which reports a 1. If i=0, then the search window is advanced by m−k+1 positions. Assume that i>0 and MQⱼ is the second largest indexed membership query module which reports a 1. In this case, before advancing the search window, one can further query MQ₁, MQ₂, . . . , and MQₘ₋ₖ₊₁ with tₕ₊ₘ₋ₖ₋₁tₕ₊ₘ₋ₖ . . . tₕ₊ₘ₋₂. If MQᵢ₋₁ reports a 1, then it is confirmed that the search window can only be advanced by m−k+1−i positions. On the other hand, if MQᵢ₋₁ reports a 0, then the search window can be advanced by m−k+1−j positions without missing any pattern occurrence. The idea can be easily generalized. Assume that when queried by substring tₕ₊ₘ₋ₖtₕ₊ₘ₋ₖ₊₁ . . . tₕ₊ₘ₋₁, MQᵢ_{₁}MQᵢ_{₂}, . . . and MQᵢ_{ⱼ} (1≦i₁<i₂< . . . <iⱼ≦m−k+1) report 1's. Then the search window can be advanced by m−k+1−iᵤ positions if MQᵢ_{_{M}}₋₁ reports a 1 and MQᵢ_{ᵥ}₋₁ reports a 0 for all v>u (iᵥ is null if u=j) when substring tₕ₊ₘ₋ₖ₋₁tₕ₊ₘ₋ₖ . . . tₕ₊ₘ₋₂ is used for query. In general, one can perform q+1 queries with substrings tₕ₊ₘ₋ₖ₋ⱼtₕ₊ₘ₋ₖ₊₁₋ⱼ . . . t_{h+M-1-j} (j=0, 1, . . . , q) and the search window can be advanced by m−k+1−iᵤ positions if iᵤ is the largest index such that MQᵢ_{_{M}}₋ⱼ reports a 1 in the j^{th} query for all j=0, 1, 2, . . . , q. FIG. 7 illustrates this embodiment.

The data inside the search window 504 in FIG. 7 are [9 B C 0 0 7 4 E]. The comparison of [7 4 E] with the query modules leads to query module MQ6 returning 1. This result is the same as the previous example shown in FIG. 6 and means that there is a potential virus in the data stream. However, before sending the data stream for further virus checking, an additional query can be made by comparing [0 7 4] with the query modules. If there is a potential virus in the search window, the comparison of [0 7 4] should cause MQ5 to yield a 1. But since none of MQs return a 1 except for MQ0, it can be concluded that there is no potential viruses in the search window 504 and the search window 504 can be safely right shifted by 6. (This sentence is not necessary. In this example, the search window can still be advanced by 6 because, when queried with [7 4 E], MQ2 reports a 0. It can only be advanced by 5 if MQ2 reported a 1 when queried with [7 4 E].) This embodiment reduces the possibility of a false positive before sending the incoming data for a time consuming virus checking.

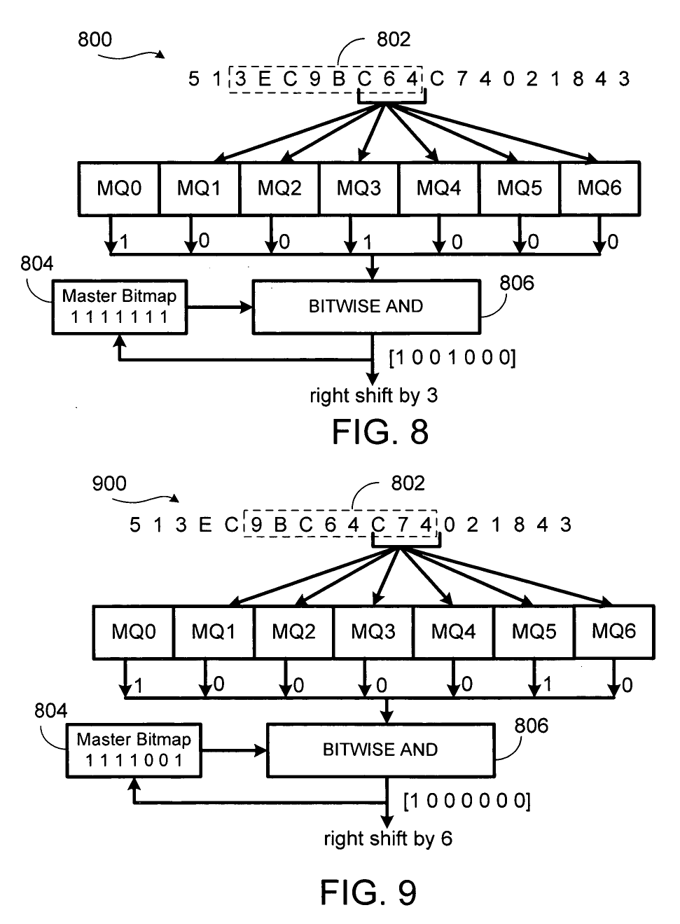

As mentioned before, the pre-filtering process can be made more efficient with use of a master bitmap as illustrated by FIGS. 8 and 9. In FIG. 8, a master bitmap 804 initially loaded with all “1” and a bitwise AND operator 806 are used. The bitwise AND operator 806 performs a bitwise AND operation between the comparison results from the query modules of FIG. 4 and the content of the master bitmap 804. The comparison result indicates a shift of three positions ([1001000]) and the bitwise AND operation does not alter the result. The result of the bitwise AND operation is right shifted three positions with leftmost positions filled with “1” and [11111001] is then stored in the master bitmap 804. FIG. 9 indicates the same data stream after the search window shifted three positions. The query modules of FIG. 4 provide a result of [1000010], which indicates a shift of one position. However, after the result from the query modules is ANDed with the master bitmap 804, the new result indicates shifting of six positions and the search window 802 will be shifted six positions instead of one position.

Each time the search window is advanced to cover some new incoming data, and these new data need to be read from an external memory for comparison with the query modules. It is noted that the query result for the current search window can be reused after the search window is advanced to reduce the number memory accesses. For example, assume that, as described above, the system performs q+1 (q>0) queries for a search window and the results suggest an advancement of x positions. If x<q, then the result of the j^{th} query (x≦j≦q) for the current search window is the same as the result of the (j-x)^{th} query for the advanced search window. Therefore, some query results can be reused to speed up the pre-filtering process.

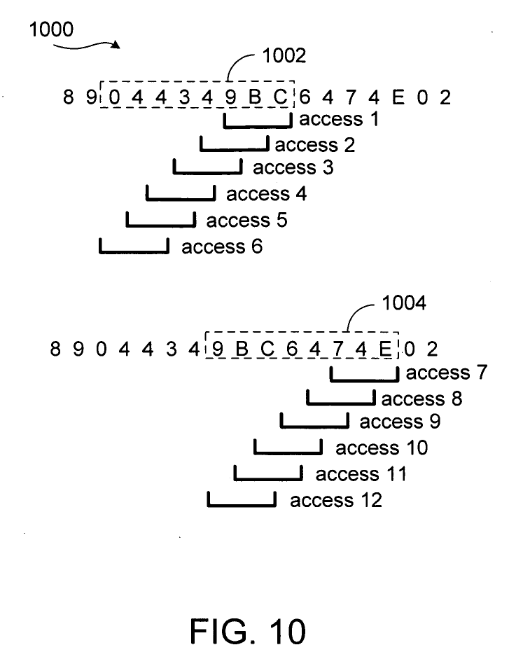

FIG. 10 illustrates two search windows 1002, 1004 shown previously in FIGS. 5 and 6 respectively. To access data of the search window 1002, if we take three data each time, it will take six accesses, and the same goes for the search window 1004. However, the data from access 1 is the same as from access 12. Therefore, if the data from access 1 is saved, then there is no need to perform access 12.

In the basic pre-filter design, there are m−k+1 membership query modules for given m and k. It is possible to add more membership query modules to reduce the false positive probability. In fact, one can easily create f more membership query modules with f different hash functions Hg, 1≦g≦f. For pattern Pᵢ, H_{d}(Pᵢ) is a member stored in the dth additional membership query module. Note that the substrings used to generate MQ₁, MQ₂, . . . , and MQₘ₋ₖ₊₁ are results of particular hash functions and thus Hg, 1≦g≦f, should be different from those functions. These additional modules are queried only if the search window cannot be advanced, i.e., a potential pattern occurrence is detected. With these additional modules, the verification scheme is invoked only if the search window cannot be advanced based on MQ₁, MQ₂, . . . , and MQₘ₋ₖ₊₁ and all these additional modules return positive reports. The search window is advanced by one position if no advancement is suggested based on MQ₁, MQ₂, . . . , and MQₘ₋ₖ₊₁ and at least one additional module returns a negative report.

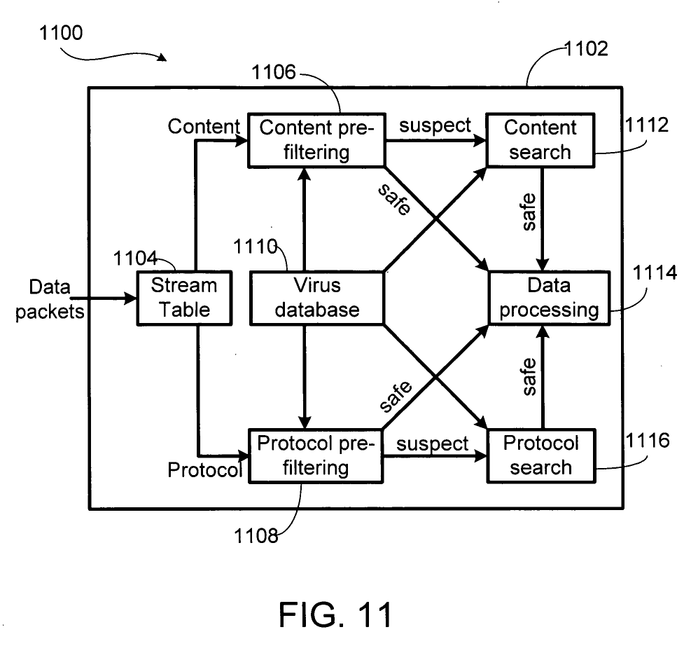

FIG. 11 illustrates an exemplary architecture 1100 of a server 1102 supporting the invention. Data packets for an application are received from a network and are processed by a stream table 1104. The protocol portion of the data is sent to a protocol pre-filtering unit 1108 and the content portion of the data is sent to a content pre-filtering unit 1106. The following description will concentrate on the pre-filtering of the content. A virus database 1110 provides information on known virus to the pre-filtering unit 1106. The pre-filtering described above is performed by the content pre-filtering unit 1106. If a content (a data stream) is found to be suspicious, it is forwarded to a content search unit 1112, where the content will be fully searched against all known virus from the virus database 1110. If the content is found to be safe, it is forwarded to a data processing unit 1114. If the content sent to the content search unit 1112 is found to be safe, the case of a false positive, the content is also forwarded to the data processing unit 1114. If the content is found to have virus, it is quarantined and may be destroyed. The virus database 1110 should be constantly updated with the latest virus information. Other elements, such as a controller and input/output units, not essential to the description of pre-filtering are not illustrated and described here.

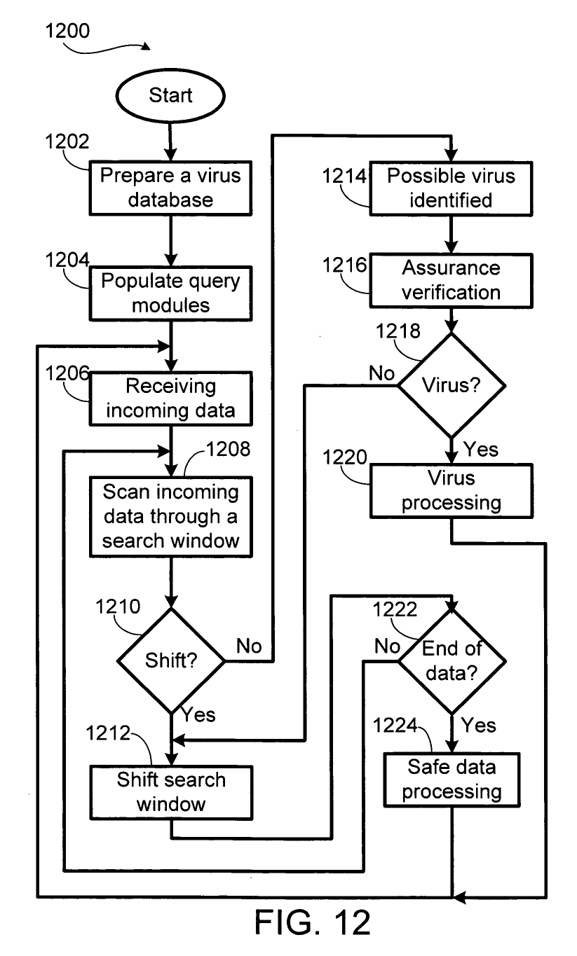

FIG. 12 illustrates a pre-filtering process 1200. The server 1102 creates a virus database, step 1202, as explained above and this virus database is used for populating query modules, step 1204. The server 1102 receives incoming data, step 1206, and the incoming data are loaded into a search window. The incoming data are searched through the search window, step 1208. The scanning result will indicate whether to shift the search window. If the scanning result indicates a shift, the search window will be shifted by a number of positions indicated from the scanning and new data loaded into the search window, step 1212. After the shifting, it is checked whether the end of the data string has been reached, step 1222. If the end of the data string has not been reached, the scanning of the data continues with new data being loaded into the scanning window and searched, step 1208. If the end of the data string has been reached, the data string is safe and will be forwarded for further data processing, step 1224, and a new incoming data is received for scanning, step 1206.

If the scanning result indicates no shift, which indicates a possible virus has been identified, step 1214, the server 1102 may perform further testing to eliminate false positives, step 1216. This further assurance verification can be done according to the explanation provided above for FIG. 7. If the assurance verification further indicates a possibility of a virus, step 1218, the data is sent for virus processing, step 1220. If the assurance verification indicates that it is a false positive, and then the search window is shifted accordingly, step 1212, and scanning continues.

In view of the method being executable on networking devices and servers, the method can be performed by a program resident in a computer readable medium, where the program directs a server or other computer device having a computer platform to perform the steps of the method. The computer readable medium can be the memory of the server, or can be in a connective database. Further, the computer readable medium can be in a secondary storage media that is loadable onto a networking computer platform, such as a magnetic disk or tape, optical disk, hard disk, flash memory, or other storage media as is known in the art.

In the context of FIG. 10, the steps illustrated do not require or imply any particular order of actions. The actions may be executed in sequence or in parallel. The method may be implemented, for example, by operating portion(s) of a network device, such as a network router or network server, to execute a sequence of machine-readable instructions. The instructions can reside in various types of signal-bearing or data storage primary, secondary, or tertiary media. The media may comprise, for example, RAM (not shown) accessible by, or residing within, the components of the network device. Whether contained in RAM, a diskette, or other secondary storage media, the instructions may be stored on a variety of machine-readable data storage media, such as DASD storage (e.g., a conventional “hard drive” or a RAID array), magnetic tape, electronic read-only memory (e.g., ROM, EPROM, or EEPROM), flash memory cards, an optical storage device (e.g. CD-ROM, WORM, DVD, digital optical tape), paper “punch” cards, or other suitable data storage media including digital and analog transmission media.

While the invention has been particularly shown and described with reference to a preferred embodiment thereof, it will be understood by those skilled in the art that various changes in form and detail may be made without departing from the spirit and scope of the present invention as set forth in the following claims. Furthermore, although elements of the invention may be described or claimed in the singular, the plural is contemplated unless limitation to the singular is explicitly stated.

What is claimed is:

1. A method for a computing device to identify undesirable data in a data stream, wherein the data stream is received from a network and may contain undesirable data, the computing device having a plurality of undesirable data, comprising the steps of:
creating a database of undesirable data;
populating a plurality of query modules with the undesirable data from the database;
receiving a data stream;
loading a search window with data from the data stream;
comparing the search window with the plurality of query modules; and
if a first comparison result indicates no shifting, identifying the data stream as undesirable data.

2. The method of claim 1, further comprising the step of shifting the search window to a first direction according to the first comparison result.

3. The method of claim 2, further comprising the step of loading the search window according to the first comparison result.

4. The method of claim 3, further comprising the steps of, if shifting is less than predetermined positions, moving some data in the search window to new positions within the search window according to the first comparison result.

5. The method of claim 1, further comprising the step of defining a width for the search window.

6. The method of claim 1, wherein the step of creating a database of undesirable data further comprising the step of storing corresponding bits of undesirable data in contiguous memory locations.

7. The method of claim 1, wherein the step of identifying the data stream as undesirable data further comprising steps for:
shifting the search window to a second direction;
comparing the data stream through the search window with the plurality of query modules; and
if a second comparison result indicates no shifting, identifying the data stream as undesirable data.

8. The method of claim 7, further comprising the step of, if the second comparison result indicates shifting, shifting the search window to the first direction according to the second comparison result.

9. The method of claim 1, wherein the step of identifying the data stream as undesirable data further comprising steps for:
comparing the search window with a second plurality of query modules, wherein each query module in the second plurality of query modules being populated with data from a second database; and
if a third comparison result indicates no shifting, identifying the data stream as undesirable data.

10. An apparatus for identifying unsafe data in a data stream, wherein the data stream is received from a network, each unsafe datum being identified by a unique data signature, comprising:
a data receiver for receiving a data stream from a data source;
a search window for loading data from the data stream;
a plurality of query modules, each query module being populated with unsafe data and capable of comparing the data with the data in the search window; and
a shift detector for receiving results from the plurality of query modules,
wherein if the shift detector indicates no shifting, the data stream is classified as unsafe data.

11. The apparatus of claim 10, further comprising a query module that always returning a positive result.

12. The apparatus of claim 10, further comprising a database of unsafe data.

13. The apparatus of claim 10, further comprising a content search engine for analyzing the data that is classified as unsafe data.

14. The apparatus of claim 10, further comprising a data processing unit for processing safe data.

15. The apparatus of claim 10, further comprising a master bitmap.

16. The apparatus of claim 10, further comprising a bitwise AND operator for ANDing the results from the plurality of query modules with a content from the master bitmap.

17. A computer-readable medium on which is stored a computer program for a computing device to identify undesirable data in a data stream, wherein the data stream is received from a network and may contain undesirable data, each undesirable datum being identified by a unique data signature and the computing device having a plurality of undesirable data signatures identifying undesirable data, the computer program comprising computer instructions that when executed by a computing device performs the steps for:
creating a database of undesirable data;
populating a plurality of query modules with the undesirable data from the database;
receiving the data stream;
loading a search window with data from the data stream;
comparing the search window with the plurality of query modules; and
if a first comparison result indicates no shifting, identifying the data stream as undesirable data.

18. The computer program of claim 17, further performing the step of shifting the search window to a first direction according to the first comparison result.

19. The computer program of claim 18, further performing the step of loading the search window according to the first comparison result.

20. The computer program of claim 19, further performing the steps of, if shifting is fewer than a predetermined positions, moving some data in the search window to new positions within the search window according to the first comparison result.

21. The computer program of claim 17, further performing the step of defining a width for the search window.

22. The computer program of claim 17, wherein the step of creating a database of undesirable data further comprising the step of storing corresponding bits of undesirable data in contiguous memory locations.

23. The computer program of claim 17, wherein the step of identifying the data stream as undesirable data further comprising steps for:
shifting the search window to a second direction;
comparing the data stream through the search window with the plurality of query modules; and
if a second comparison result indicates no shifting, identifying the data stream as undesirable data.

24. The computer program of claim 23, further comprising the step of, if the second comparison result indicates shifting, shifting the search window to the first direction according to the second comparison result.

25. A method for a computing device to identify undesirable data in a data stream, wherein the data stream is received from a network and may contain undesirable data, the computing device having a plurality of undesirable data, comprising the steps of:
creating a database of undesirable data;
populating a plurality of query modules with the undesirable data from the database;
receiving the data stream;
loading a search window with data from the data stream;
comparing the search window with the plurality of query modules;
ANDing a first comparison result with a master bitmap; and
if an ANDing result indicates no shifting, identifying the data stream as undesirable data.

26. The method of claim 25, further comprising the step of shifting the search window to a first direction according to the ANDing result.

27. The method of claim 26, further comprising the step of loading the search window according to the ANDing result.

28. The method of claim 27, further comprising the steps of, if shifting is less than predetermined positions, moving some data in the search window to new positions within the search window according to the ANDing result.

29. The method of claim 25, further comprising the step of defining a width for the search window.

30. The method of claim 25, wherein the step of creating a database of undesirable data further comprising the step of storing corresponding bits of undesirable data in contiguous memory locations.

31. The method of claim 25, wherein the step of identifying the data stream as undesirable data further comprising steps for:
comparing the search window with a second plurality of query modules, wherein each query module in the second plurality of query modules being populated with data from a second database; and
if a third comparison result indicates no shifting, identifying the data stream as undesirable data.
